(19) United States
(12) Patent Application Publication
(10) Pub. No.: US 2025/0375781 A1
(43) Pub. Date: Dec. 11, 2025

(54) Applicator for Electrostatic Deposition Coating of Continuous Moving Web

(71) Applicant: AM Batteries, Inc., Billerica, MA (US)

(72) Inventors: Omri Flaisher, Litchfield, NH (US); Jay Jie Shi, Acton, MA (US); Jennifer R. Swenson, Yorktown, IN (US); Han Almekinders, Retranchement (NL)

(73) Assignee: AM Batteries, Inc., Billerica, MA (US)

(21) Appl. No.: 18/877,499

(22) PCT Filed: Jun. 27, 2023
(86) PCT No.: PCT/US2023/026276

§ 371 Date: Dec. 20, 2024

Related U.S. Application Data
(60) Provisional application No. 63/356,199, filed on Jun. 28, 2022.

(51) Int. Cl. B05B 5/08; B05B 5/14; H01M 4/04

(52) U.S. Cl. CPC B05B 5/081; B05B 5/087; B05B 5/14; H01M 4/0419

(57) ABSTRACT

An applicator for electrostatic deposition of dry powder on a grounded continuous moving electrically conductive web is provided that includes a powder feeding system, at least one powder dispenser, an electrostatic deposition chamber, and at least one wire electrode in the electrostatic deposition chamber. An opening of a powder dispenser outlet is arranged along the latitude of the electrically conductive web, and the ratio of the width of the outlet opening and the coating width of the web is in the range of 0.25-1.0. The powder dispenser has a defined angle relative to the web and a vertical distance between the powder dispenser outlet and the web. The first wire electrode generates a corona discharge zone with a radius and have a vertical distance between the web.

### CROSS-REFERENCE TO RELATED APPLICATIONS

This application claims the benefit of a co-pending, commonly assigned U.S. Provisional Patent Application No. 63/356,199, which was filed on Jun. 28, 2022. The entire content of the foregoing provisional application is incorporated herein by reference.

### BACKGROUND

Articles have previously discussed the application of the electrostatic spray deposition (ESD) technique for solvent-free composite electrode coating of Li-ion batteries. The solvent-free electrode coating technology is attractive since it can significantly reduce energy consumption in the manufacturing process and, thereby, significantly reduce the manufacturing cost of batteries. In principle, the ESD technique allows a simpler and more flexible electrode coating due to direct deposition of composite electrode powders on the metallic current collector through an electrostatic spray deposition process.

ESD is widely used in dry powder coating for metallic parts. For the ESD coating, the coating layer quality and transfer efficiency is directly related to properties of particles of the coating powder. A typical electrostatic deposition applicator for dry powder coating can include a powder hopper, a powder fluidizing system, a powder diffusion and cloudification system, a powder corona charging system, a powder deposition system, and a powder reclaiming system.

FIG. 1 illustrates a conventional electrostatic deposition gun or applicator 10. The conventional electrostatic deposition applicator 10 can have a gun-shape powder diffusion and cloudification system. The applicator 10 can include a powder inlet 12 and an electrostatic spray nozzle 14 for deposition of powder onto a grounded web 16 having a web moving direction 18. The fluidized powder is carried by a pressured gas and passes through the nozzle 14 with an electrode. The powder is corona charged by the electrode and diffused and cloudified through the nozzle 14, and the charged powder flow deposits onto a grounded electric conductive substrate (e.g., the grounded web 16).

The “transfer efficiency” of an ESD system is the ratio of the mass of electrostatic charged particles deposited on the conductive substrate and the total mass of fluidized particles. A higher transfer efficiency means more particles are deposited onto the conductive substrate, resulting in higher utilization of coating materials. The “uniformity” of the deposited layer includes the consistency of the chemical stoichiometry between the deposited layer and the feedstock powder mixture, and the consistency of chemical stoichiometric and geometric consistency within the deposited layer.

In a conventional ESD design, the sprayed powder is diffused in a cone shape, which deposits on the substrate 16 in a general pattern based on the nozzle tip. In the system depicted in FIG. 1, a circular nozzle tip/deflector is used, leading to a circular spray pattern (e.g., a circular deposition area 20). In a continuous moving web or substrate 16 with a targeted coating width of L, if the diameter of coating circle D is less than the targeted coating width L, the coating will not cover the width of the web 16, leading to poor coating uniformity. If the diameter of coating circle D is larger than the targeted coating width L, while the uniformity may be improved, the transfer efficiency will be lowered due to excessive overspray. In some instances, the targeted coating width L can be equal or less than the web 16 width. However, for the convenience of describing the technology, the targeted coating width L is considered equal to the web 16 width hereafter.

Conventional ESD system designs generally use a point electrode which creates a gradient in the electric field as it relates to the web 16 width. When the electrode is a point charge in the center of width of web 16, the electric field strength as it relates to the web 16 is at a maximum immediately underneath the electrode and at a minimum at the edges of the web 16 due to the separation distance. This inherent geometrical non-uniformity in the electric field leads to poor uniformity across the width of web 16.

Further, when the powder cloud density is high, the corona discharge created by the point electrode tends to become suppressed. Since the gun nozzle and electrode tip in a conventional ESD design are coupled together, coating at high mass flow rates results in low transfer efficiency and uniformity due to poor chargeability of the powder particles. Thus, the conventional ESD design can be limited to relatively low powder mass flow rates.

### SUMMARY

Embodiments of the present disclosure provide an exemplary applicator for electrostatic deposition coating of a continuous moving web. The electrostatic deposition applicator for dry powder coating of a continuous moving electric conductive web provides improved coating uniformity and transfer efficiency, and an increased powder deposition rate and coating layer thickness.

In accordance with embodiments of the present disclosure, an exemplary system applicator (e.g., a system or applicator system) for electrostatic deposition of dry powder on a grounded continuous moving electrically conductive web is provided. The applicator includes a powder feeding system, at least one powder dispenser, an electrostatic deposition chamber, and at least one wire electrode in the electrostatic deposition chamber. An opening of a powder dispenser outlet of the at least one dispenser is arranged along a latitude of the electrically conductive web, and a ratio (P) of a width (W) of the opening and a coating width (L) of the electrically conductive web is in a range of about 0.25-1.0 cm. The at least one powder dispenser includes a defined angle (α) relative to the electrically conductive web and a vertical distance between the powder dispenser outlet and the electrically conductive web (h_{d}). A first wire electrode of the at least one wire electrode generates a corona discharge zone with a radius (R) and is disposed at a vertical distance relative to the electrically conductive web (hₑ). The powder dispenser outlet and the first wire electrode are at a horizontal distance (d1). The following relationship and condition is satisfied:

$$[ {tan}^{- 1} \frac{( {h}_{e} - {h}_{d} )}{d 1} - {sin}^{- 1} \frac{R}{\sqrt{{( {h}_{e} - {h}_{d} )}^{2} + d {1}^{2}}} ] < α < [ {tan}^{- 1} \frac{( {h}_{e} - {h}_{d} )}{d 1} + {sin}^{- 1} \frac{R}{\sqrt{{( {h}_{e} - {h}_{d} )}^{2} + d {1}^{2}}} ] .$$

In some embodiments, the electrostatic deposition chamber includes two or more wire electrodes. In such embodiments, the two or more wire electrodes are arranged in parallel and cross the width of the continuous moving electrically conductive web. In some embodiments, the radius (R) of the corona discharge zone generated by the first wire electrode can be in a range of about 1 cm to 20 cm. In some embodiments, the vertical distance between the first wire electrode and the electrically conductive web (hₑ) can be in a range of about 2 cm to 30 cm. In some embodiments, the vertical distance between the powder dispenser outlet and the electrically conductive web (h_{d}) can be in a range of about 2 cm to 70 cm.

The powder dispenser outlet can be arranged outside of the corona discharge zone generated by the first wire electrode. In some embodiments, the horizontal distance between the at least one powder dispenser and the first wire electrode (d1) can be about 2-40 cm. In some embodiments, a number of the two or more wire electrodes (Nₑ) can be determined by:

$$Ne = \frac{d - {d}_{1} - {d}_{3}}{{d}_{2}} ,$$

where: d is a horizontal distance between an edge of powder deposition on the electrically conductive web and the powder dispenser outlet, d₁ is a horizontal distance between the first wire electrode and the powder dispenser outlet, d₂ is a horizontal separation between two adjacent wire electrode, and d₃ is a horizontal distance between the edge of powder deposition on the electrically conductive web and a last wire electrode of the two or more wire electrodes.

In some embodiments, the horizontal separation between the two adjacent wire electrodes (d₂) can be in a range of R to 2R. In some embodiments, the horizontal distance (d₃) between the edge of powder deposition on the electrically conductive web and the last wire electrode can be within the radius (R). In some embodiments, a second or n^{th} wire electrode of the two or more wire electrodes has the same or slightly less vertical distance between the electrically conductive web as the first electrode or (n−1)^{th} wire electrode, and the vertical distance between the last wire electrode and the electrically conductive web is more than 5 cm.

the at least one wire electrode includes two or more wire electrodes, and a voltage of two or more wire electrodes is different. The electrostatic deposition chamber includes deflectors, and a number of the deflectors is equal to a number of wire electrodes. In some embodiments, the applicator can include a powder reclaiming system. The powder reclaiming system can include at least one powder collection port with at least two turbulence eliminating baffles located in-between the electrically conductive web and the powder collection port. The powder collection port can be disposed on top of the electrostatic deposition chamber, or at a bottom of the electrostatic deposition chamber, or a combination thereof.

In some embodiments, the at least one powder dispenser can include two powder dispensers. In some embodiments, the two powder dispensers can be arranged to face each other along a longitude direction of the electrically conductive web in a mirror image orientation. In some embodiments, a horizontal distance between the two powder dispensers can be twice of a horizontal distance between an edge of powder deposition on the electrically conductive web and a powder dispenser outlet plus about 0-20 cm. In some embodiments, the two powder dispensers can be arranged on a top side of the electrically conductive web and a back side of the electrically conductive web with a mirror image orientation.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the applicator for electrostatic deposition coating, reference is made to the accompanying figures, wherein:

FIG. 1 is a diagrammatic view of a conventional electrostatic spray deposition gun;

FIG. 2 is a diagrammatic view of an exemplary application for electrostatic deposition coating in accordance with embodiments of the present disclosure;

FIG. 3 is a diagrammatic view of a corona discharge zone;

FIG. 4A is a diagrammatic side view of an exemplary powder dispenser in accordance with embodiments of the present disclosure;

FIG. 4B is a diagrammatic top view of an exemplary powder dispenser of FIG. 4A;

FIG. 5 is a diagrammatic view of an exemplary electrostatic deposition coating chamber in accordance with embodiments of the present disclosure;

FIG. 6 is a diagrammatic view of an exemplary electrostatic deposition coating chamber in accordance with embodiments of the present disclosure;

FIG. 7 is a diagrammatic view of an exemplary electrostatic deposition coating chamber in accordance with embodiments of the present disclosure;

FIG. 8 is a diagrammatic view of an exemplary electrostatic deposition coating chamber with powder reclaiming in accordance with embodiments of the present disclosure;

FIG. 9 is a table of experimental setup conditions for testing of an exemplary electrostatic deposition coating applicator;

FIG. 10 is a table of transfer efficiency results from testing of an exemplary electrostatic deposition coating applicator;

FIG. 11 is a table of experimental setup conditions for testing of an exemplary electrostatic deposition coating applicator including multiple discharge electrodes; and

FIG. 12 is a table of transfer efficiency results from testing of an exemplary electrostatic deposition coating applicator including multiple wire comparison.

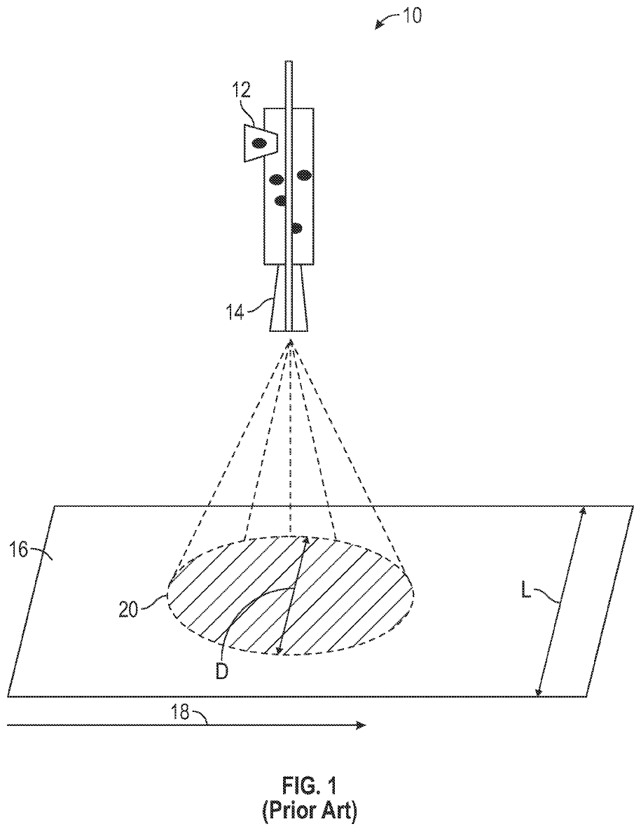

### DETAILED DESCRIPTION

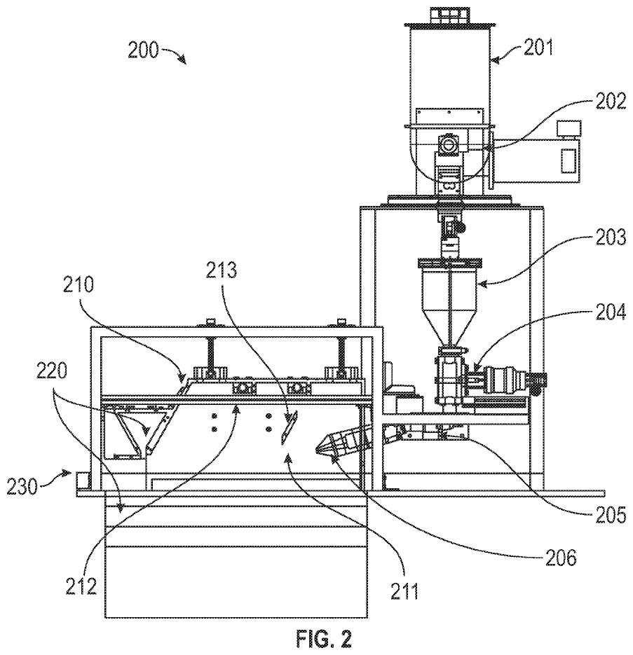

FIG. 2 is a diagrammatic view of an exemplary applicator for dry powder electrostatic depositing coating (hereinafter “applicator 200”). The applicator 200 can be referred to herein as a “system”. As shown in FIG. 2, the applicator 200 can include a powder metering device hopper 201, a powder metering device 202, a powder feeding device hopper 203, and a powder feeding device 204. The applicator 200 can include a powder dispenser 205, an ESD chamber, 210 and one or more powder reclaiming system ports 220. The ESD chamber 210 includes one or more wire electrodes 211, an electrode drawer 212, and one or more electric field deflectors 213.

According to exemplary implementations of the disclosed ESD system, dry powder for deposition is loaded into the powder metering device hopper 201. The powder is fed from the powder metering device hopper 201 into the powder metering device 202 via gravity, although alternative feed mechanisms may be employed, e.g., belts conveyors, screw conveyors, pneumatic conveyors, vibratory conveyors, tube-and-chain conveyors, any other dry bulk powder handling system, combinations thereof, or the like. The powder metering device 202 precisely meters the powder into the powder feeding device hopper 201 so as to maintain a consistent powder head pressure for the powder feeding device 204. The powder feeding device 204 de-agglomerates and precisely feeds the powder into the powder dispenser 205.

The powder is drawn into the dispenser 205 by gravity and negative pressure caused by the Venturi effect of air jets (not shown) which insert air to convey axially, diffuse and further de-agglomerate the powder and disperse it as an aerated powder cloud out of the powder dispenser 205 through the outlet 206 into the ESD chamber 210. The air jets can be oriented to control the direction of powder dispersion and movement into the ESD chamber 210. The powder dispenser 205 can dispense powder via injecting and diffusing air into and through the powder feed stream. In some embodiments, the powder dispenser 205 can convey, diffuse, and de-agglomerate powder by other suitable means. For example, an alternative or additional method could use a brush feeding and diffusion system, as disclosed in U.S. Pat. No. 5,769,276, the content of which is incorporated herein by reference. The charged powder particles that are dispensed deposit on the grounded electrically conductive substrate web 230.

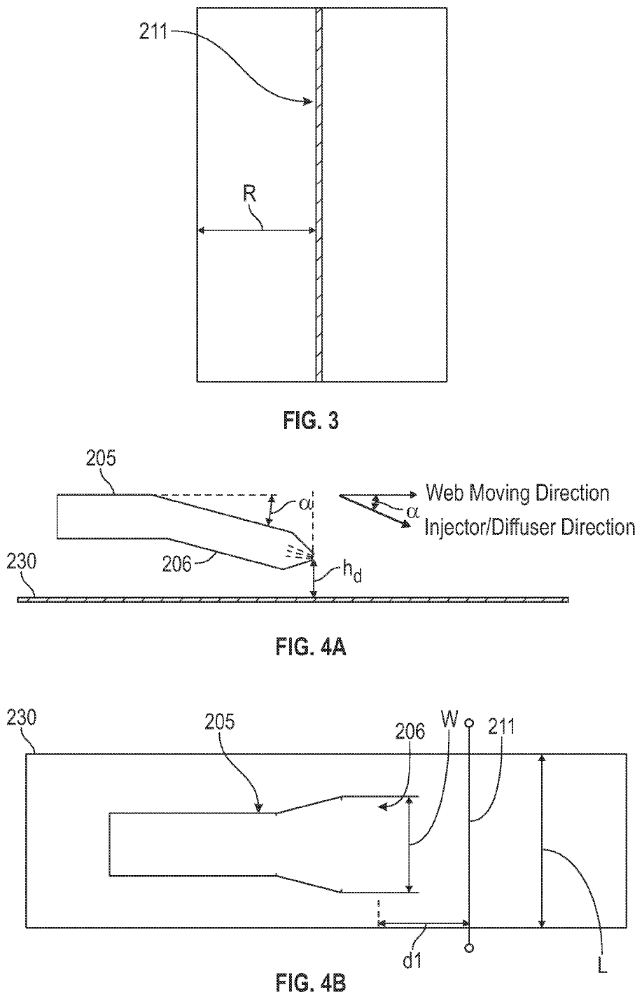

The powder particles are diffused as powder cloud through the powder dispenser outlet 206. The shape of the powder dispenser outlet 206 can take various forms, e.g., rectangular, oval, or the like. The powder dispenser outlet 206 is elongated along the web width, e.g., dimensioned greater at the outlet 206 than the remaining width of the powder dispenser 205 (see, e.g., FIG. 4B). Inside the ESD chamber 210 one or more wire electrodes 211 are mounted parallel across the width of the ESD chamber 210 and oriented perpendicular to the direction of movement of the powder cloud and web 230. When a high negative voltage is applied to the wire electrodes 211, a corona discharge is generated where free electrons and air molecule ions are present in the ESD chamber 210 (see, e.g., FIG. 3). The voltage required to create the corona discharge is called the “corona onset voltage”. This corona discharge is most heavily concentrated around a certain radius R perpendicular to the wire electrode 211 surface, which is defined and referred to herein as the “corona discharge zone”. R is defined as the radial distance from the wire electrode 211 where the measured voltage is equal to the corona onset voltage. Typically, the corona onset voltage is approximately 18 kV in air. For example, if the applied voltage for the wire electrode 211 is 50 kV and the measured voltage 15 cm radially from the wire electrode 211 is 18 kV, then the corona discharge zone is defined with a radius R of 15 cm.

The process and design parameters for the wire electrode 211 that determine the size of the corona discharge zone are the applied voltage, the applied current, the cross-sectional size of the wire electrode 211, the shape of the wire electrode 211, and the material of the wire electrode 211. A circular cross-section of the wire electrode 211 may be preferable to assume electric field symmetry, although other cross-sectional shapes of the wire electrode 211 could be used in the system.

When powder particles travel through the corona discharge zone, electrostatic charge accumulates on the surface of the powder particles due to field charging and diffusion charging from ions produced from the corona discharge. The accumulated charge as a function of time, qₜ, as well as the saturation charge of a particle, qₘ, is described by the Pauthenier's equation as shown below in Equations 1 and 2.

$${q}_{m} = 4 π {ε}_{0} ( 1 + 2 \frac{{ε}_{r} - 1}{{ε}_{r} + 1} ) {Er}^{2} \qquad ( 1 )$$

$$q ( t ) = 4 π {ε}_{0} ( 1 + 2 \frac{{ε}_{r} - 1}{{ε}_{r} + 1} ) {r}^{2} E \frac{enkt}{4 {ε}_{0} + enkt} \qquad ( 2 )$$

where r is the radius of the particle, E is the electric field strength, e is the charge of an electron, k is the electron mobility, n is the electron concentration, t is the time, ε₀ is the absolute permittivity, and εᵣ is the relative permittivity of powder.

The ability of a powder particle to effectively obtain a surface charge and uniformly deposit onto the grounded conductive substrate can be significantly influenced by several geometric factors related to the relative placement of the powder dispenser outlet, the placement of the wire electrode(s), and the location of the grounded web. The primary forces which influence the trajectory of a powder particle in this system can be categorized as kinetic and electrostatic forces. The kinetic forces are controlled by the powder dispenser air setting and positioning, the ESD chamber design (affecting the distribution of flow fields), and the powder reclaiming system negative pressure magnitude, geometric design, and relative placement in the ESD chamber. The electrostatic forces are mainly determined by the wire electrodes voltage, current, and positioning, and the electric field deflectors positioning and size.

To obtain a highly uniform powder particle electrostatic deposition, it is critical to enable the electrostatic forces to be the primary forces during deposition. Especially when high coating rates are required, the initial kinetic momentum of powder particles exiting the powder dispenser outlet can be substantially large. Whenever possible, the exit velocity of powder particles leaving the powder dispenser outlet should be minimized. When this exit velocity has been minimized to a target range between about 100-1300 ft/min (not less than 35 ft/min and not greater than 2,000 ft/min), the positioning of functional components within the ESD chamber are critical to maximize the electrostatic forces during final deposition on the grounded web as it relates to the exit velocity and relative trajectory of powder particles. In some embodiments, the exit velocity can be minimized to a target range of between about, e.g., 100-1300 ft/min inclusive, 200-1300 ft/min inclusive, 300-1300 ft/min inclusive, 400-1300 ft/min inclusive, 500-1300 ft/min inclusive, 600-1300 ft/min inclusive, 700-1300 ft/min inclusive, 800-1300 ft/min inclusive, 900-1300 ft/min inclusive, 1000-1300 ft/min inclusive, 1100-1300 ft/min inclusive, 1200-1300 ft/min inclusive, 100-1200 ft/min inclusive, 100-1100 ft/min inclusive, 100-1000 ft/min inclusive, 100-900 ft/min inclusive, 100-800 ft/min inclusive, 100-700 ft/min inclusive, 100-600 ft/min inclusive, 100-500 ft/min inclusive, 100-400 ft/min inclusive, 100-300 ft/min inclusive, 100-200 ft/min inclusive, 100 ft/min, 200 ft/min, 300 ft/min, 400 ft/min, 500 ft/min, 600 ft/min, 700 ft/min, 800 ft/min, 900 ft/min, 1000 ft/min, 1100 ft/min, 1200 ft/min, 1300 ft/min, or the like.

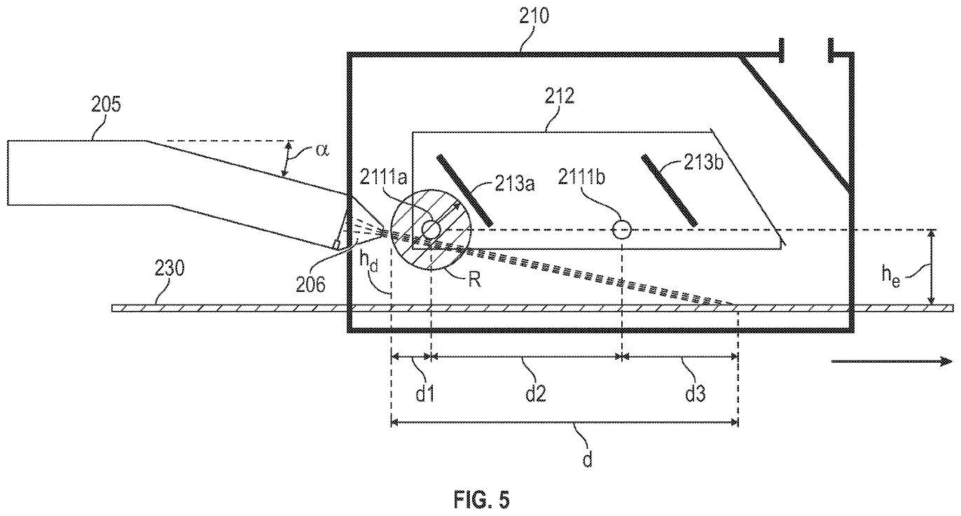

The following discussion focuses on the relative positioning between critical components affecting particle trajectory, chargeability, and final deposition capability. FIG. 4A is a side view and FIG. 4B is a top view of a powder dispenser 205 within the ESD chamber 210, and FIG. 5 is another side view of the powder dispenser 205 relative to the ESD chamber 210. FIGS. 4A, 4B and 5 show the main positioning variables that are critical to balance relative to each other to obtain a high degree of deposition uniformity. The noted variables include the angle α between the dispenser 205 arrangement and the web 230, hₑ which represents the vertical distance between the web 230 and the first wire electrode 211a, h_{d} which represents the vertical distance between the web 230 and the dispenser outlet 206, R which represents the radius of the corona discharge zone created by the first wire electrode 21a1, d1 which represents the horizontal distance between the powder dispenser outlet 206 and the first wire electrode 211a, and the relative size W of the powder dispenser outlet 206 as it relates to the web width L.

The width W of the powder dispenser outlet opening 206 generally determines the span of the powder cloud over the web 230 directly after the powder cloud is ejected from the powder dispenser 205 (see, e.g., FIG. 4B). The width W and angle α of the opening of outlet 206 of powder dispenser 205 are selected and designed to meet the following requirements: (1) the powder particles are diffused from the outlet 206 of dispenser 205 to allow all particles (with a minimum of approximately 80% and a target of greater than 95%) to be charged readily and uniformly in the corona discharge zone by the electrode wire(s) 211; (2) the exiting powder cloud from the powder dispenser outlet 206 is of a planar geometry and the width W in the charging zone matches the width L of the web 230 so there is minimum of overspray (with a target of 5-10% and a maximum overspray of 50% from the total powder dispensed) between the sides of the web 230 and the adjacent walls of the coating chamber 210; and (3) the powder trajectory is within the web width L when it passes the first wire electrode 211a to assure that there is an equivalent electrostatic potential of the powder particles in relation to the web 230.

When the ratio P of the width W of powder dispenser outlet 206 opening and the width L of the web 230 (e.g., represented by equation P=W/L) is too big (e.g., greater than about 1), the powder cloud will have overspray, resulting in low transfer efficiency. When the ratio P is too small (e.g., less than about 0.25), the powder cloud will not cover the web 230 well, resulting in low uniformity. According to the present disclosure, the ratio P of the exemplary system or applicator 200 is designed between about, e.g., 0.25-1 inclusive, 0.3-1 inclusive, 0.35-1 inclusive, 0.4-1 inclusive, 0.45-1 inclusive, 0.5-1 inclusive, 0.55-1 inclusive, 0.6-1 inclusive, 0.65-1 inclusive, 0.7-1 inclusive, 0.75-1 inclusive, 0.8-1 inclusive, 0.85-1 inclusive, 0.9-1 inclusive, 0.95-1 inclusive, 0.25-0.95 inclusive, 0.25-0.9 inclusive, 0.25-0.85 inclusive, 0.25-0.8 inclusive, 0.25-0.75 inclusive, 0.25-0.7 inclusive, 0.25-0.65 inclusive, 0.25-0.6 inclusive, 0.25-0.55 inclusive, 0.25-0.5 inclusive, 0.25-0.45 inclusive, 0.25-0.4 inclusive, 0.25-0.35 inclusive, 0.25-0.3 inclusive, 0.25, 0.3, 0.35, 0.4, 0.45, 0.5, 0.55, 0.6, 0.65, 0.7, 0.75, 0.8, 0.85, 0.9, 0.95, 1, or the like.

The combination of the relative positions of the variables listed above need to provide the following balanced function. All particles exiting the dispenser outlet 206 should travel through one of the corona discharge zones generated by the wire electrode(s) 211 to be charged to saturation charge as effectively as possible. A particle trajectory should minimize the vertical kinetic force between a powder particle and the web 230 to reduce the impact and associated potential deflection of the powder particle from the web 230. The electrostatic attraction momentum between the charged powder particle and the grounded web 230 should be greater than the inherent kinetic momentum which the particle possesses at its velocity when making contact with the web 230. This assures that electrostatic forces are the primary forces controlling deposition and reduces powder deflection from the web 230, which facilities a high degree of uniformity for coating.

To maximize the likelihood of achieving saturation charge, the angle α must be set such that the majority of the powder trajectory is directed within the corona discharge zone defined prior by the radius R perpendicular to the wire electrode 211 (e.g., greater than about 80%, greater than 85%, greater than 90%, greater than 95%, or the like). According to the present disclosure, to effectively charge powder particles, the radius of the corona discharge zone R is set in the range of about 1-20 cm with the diameter of the wire electrode 211 in the range of about 0.05-2 mm, and the applied electrode voltage in the range of about 15 kV to about 100 kV.

In some embodiments, the radius of the corona discharge zone R can be about, e.g., 1-20 cm inclusive, 1-18 cm inclusive, 1-15 cm inclusive, 1-13 cm inclusive, 1-10 cm inclusive, 1-8 cm inclusive, 1-5 cm inclusive, 1-4 cm inclusive, 1-3 cm inclusive, 1-2 cm inclusive, 2-20 cm inclusive, 3-20 cm inclusive, 4-20 cm inclusive, 5-20 cm inclusive, 8-20 cm inclusive, 10-20 cm inclusive, 13-20 cm inclusive, 15-20 cm inclusive, 18-20 cm inclusive, 1 cm, 2 cm, 3 cm, 4 cm, 5 cm, 8 cm, 10 cm, 13 cm, 15 cm, 18 cm, 20 cm, or the like. In some embodiments, the diameter of the wire electrode 211 can be in the range of about, e.g., 0.05-2 mm inclusive, 0.25-2 mm inclusive, 0.5-2 mm inclusive, 0.75-2 mm inclusive, 1-2 mm inclusive, 1.25-2 mm inclusive, 1.5-2 mm inclusive, 1.75-2 mm inclusive, 0.05-1.75 mm inclusive, 0.05-1.5 mm inclusive, 0.05-1.25 mm inclusive, 0.05-1 mm inclusive, 0.05-0.75 mm inclusive, 0.05-0.5 mm inclusive, 0.05-0.25 mm inclusive, 0.05 mm, 0.25 mm, 0.5 mm, 0.75 mm, 1 mm, 1.25 mm, 1.5 mm, 1.75 mm, 2 mm, or the like. In some embodiments, the applied electrode voltage can be in the range of about, e.g., 15-100 kV inclusive, 25-100 kV inclusive, 50-100 kV inclusive, 75-100 kV inclusive, 15-75 kV inclusive, 15-50 kV inclusive, 15-25 kV inclusive, 15 kV, 25 kV, 50 kV, 75 kV, 100 kV, or the like.

The angle α between the powder dispenser 205 arrangement and the web (FIG. 4A) can be varied. The angle α needs to be optimized for the application to allow (i) a higher degree of the powder particles exiting the powder dispenser 205 to be charged by the corona discharge zone located in the ESD chamber 210, and (ii) the powder cloud to be conveyed in a continuous and uniform stream from the dispenser 205 to the grounded electrically conductive web 230 at maximum transfer efficiencies and uniformity. High transfer efficiencies are achieved by minimizing the overspray in the area between the sides of the web 230 and the adjacent walls of the coating chamber 210, and minimizing air turbulences within the ESD chamber 210.

To effectively charge powder particles and enable the charged powder particles deposit on the web 230 with high uniformity according to the present disclosure, a relationship between the angle α, the position of the powder dispenser outlet 206, and the position of the first wire electrode 211a needs to satisfy the following condition as represented by Equation 3:

$$[ {tan}^{- 1} \frac{( {h}_{e} - {h}_{d} )}{d 1} - {sin}^{- 1} \frac{R}{\sqrt{{( {h}_{e} - {h}_{d} )}^{2} + d {1}^{2}}} ] < α < [ {tan}^{- 1} \frac{( {h}_{e} - {h}_{d} )}{d 1} + {sin}^{- 1} \frac{R}{\sqrt{{( {h}_{e} - {h}_{d} )}^{2} + d {1}^{2}}} ] \qquad ( 3 )$$

where hₑ is the vertical distance between the first wire electrode 211a and the web 230, h_{d} is the vertical distance between the powder dispenser outlet 206 and the web 230, R is the radius of the corona discharge zone, and d1 is the horizontal distance between the powder dispenser 205 and the first wire electrode 211a.

To demonstrate the importance of this geometric relationship for particle charging and thus transfer efficiency, a set of experiments were completed for conditions which satisfy the above relationship and other which did not. The impact on transfer efficiency was compared. The experiment utilized a similar setup to that depicted in FIG. 5. Three conditions were trialed and compared. The applied voltage and the angle α were varied. d1, h_{d}, hₑ, and the powder mass flow rate were all held constant. For the associated discharge electrode and applied electric field strength, the corona discharge radius was measured to be about 3 cm. The web speed was operated continuously at about 1 m/min and the web width was about 260 mm.

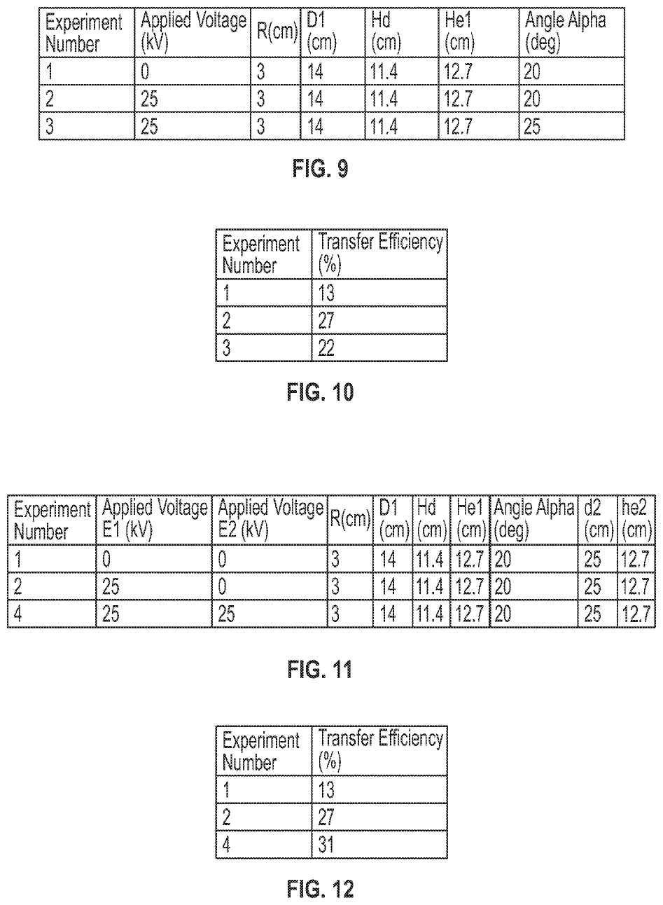

FIG. 9 shows the experimental setup conditions for the three experiments. The first experiment was operated at 0 applied voltage to demonstrate a no-charging baseline condition where the geometric configuration satisfied the relationship. Based on the amount of powder coated, the calculated transfer efficiency was 13% (FIG. 10). The second experiment was a configuration which satisfied the geometric relationship and the transfer efficiency increased to 27%, a greater than 2× increase from the no-voltage condition. The third experiment changed the angle alpha from 20 degrees to 25 degrees, which based on the calculation and the inputs, led to an unsatisfied condition to the relationship. The calculated transfer efficiency decreased to 22%, a reduction of almost 20% from the satisfied condition. The results are summarized in FIG. 10.

It should be noted that in the experimental setup, the powder output from the powder dispenser was not a discrete jet and had a vertical expansion leading to some of the powder output satisfying the condition. This is why there is still some increase from the no-voltage condition. The experiment shows that when the amount of powder targeted towards the corona discharge radius is reduced, there is a reduction in the ratio of charged particles and thus a reduction in the transfer efficiency to the grounded web.

The vertical distance between the first wire electrode 211a and the web 230 must be beyond the arching range and provides a sufficient electric field for electrostatic deposition. In some embodiments, the vertical distance between the first wire electrode 211a and the web 230 (hₑ) can be in the range of about, e.g., 2-30 cm inclusive, 3-30 cm inclusive, 4-30 cm inclusive, 5-30 cm inclusive, 10-30 cm inclusive, 15-30 cm inclusive, 20-30 cm inclusive, 25-30 cm inclusive, 2-25 cm inclusive, 2-20 cm inclusive, 2-15 cm inclusive, 2-10 cm inclusive, 2-5 cm inclusive, 2-4 cm inclusive, 2-3 cm inclusive, 5-25 cm inclusive, 5-20 cm inclusive, 5-15 cm inclusive, 5-10 cm inclusive, 2 cm, 3 cm, 4 cm, 5 cm, 10 cm, 15 cm, 20 cm, 25 cm, 30 cm, or the like.

In some embodiments, the vertical distance between the powder dispenser outlet 206 and the web 230 (h_{d}) can be set in the range of about, e.g., 2-70 cm inclusive, 3-70 cm inclusive, 4-70 cm inclusive, 5-70 cm inclusive, 10-70 cm inclusive, 15-70 cm inclusive, 20-70 cm inclusive, 25-70 cm inclusive, 30-70 cm inclusive, 35-70 cm inclusive, 40-70 cm inclusive, 45-70 cm inclusive, 50-70 cm inclusive, 55-70 cm inclusive, 60-70 cm inclusive, 65-70 cm inclusive, 2-65 cm inclusive, 2-60 cm inclusive, 2-55 cm inclusive, 2-50 cm inclusive, 2-45 cm inclusive, 2-40 cm inclusive, 2-35 cm inclusive, 2-30 cm inclusive, 2-25 cm inclusive, 2-20 cm inclusive, 2-15 cm inclusive, 2-10 cm inclusive, 2-5 cm inclusive, 2-4 cm inclusive, 2-3 cm inclusive, 5-40 cm inclusive, 10-40 cm inclusive, 15-40 cm inclusive, 20-40 cm inclusive, 25-40 cm inclusive, 30-40 cm inclusive, 35-40 cm inclusive, 5-35 cm inclusive, 5-30 cm inclusive, 5-25 cm inclusive, 5-20 cm inclusive, 5-15 cm inclusive, 5-10 cm inclusive, 2 cm, 3 cm, 4 cm, 5 cm, 10 cm, 15 cm, 20 cm, 25 cm, 30 cm, 35 cm, 40 cm, 45 cm, 50 cm, 55 cm, 60 cm, 65 cm, 70 cm, or the like.

In some embodiments, the radius of the corona discharge zone can be set in the range of about, e.g., 1-20 cm inclusive, 1-18 cm inclusive, 1-15 cm inclusive, 1-13 cm inclusive, 1-10 cm inclusive, 1-8 cm inclusive, 1-5 cm inclusive, 1-4 cm inclusive, 1-3 cm inclusive, 1-2 cm inclusive, 2-20 cm inclusive, 3-20 cm inclusive, 4-20 cm inclusive, 5-20 cm inclusive, 8-20 cm inclusive, 10-20 cm inclusive, 13-20 cm inclusive, 15-20 cm inclusive, 18-20 cm inclusive, 1 cm, 2 cm, 3 cm, 4 cm, 5 cm, 8 cm, 10 cm, 13 cm, 15 cm, 18 cm, 20 cm, or the like.

In some embodiments, the horizontal distance between the powder dispenser 205 and the first wire electrode 211a (d1) can be set in the range of about, e.g., 2-40 cm inclusive, 3-40 cm inclusive, 4-40 cm inclusive, 5-40 cm inclusive, 10-40 cm inclusive, 15-40 cm inclusive, 20-40 cm inclusive, 25-40 cm inclusive, 30-40 cm inclusive, 35-40 cm inclusive, 2-35 cm inclusive, 2-30 cm inclusive, 2-25 cm inclusive, 2-20 cm inclusive, 2-15 cm inclusive, 2-10 cm inclusive, 2-5 cm inclusive, 2-4 cm inclusive, 2-3 cm inclusive, 2 cm, 3 cm, 4 cm, 5 cm, 10 cm, 15 cm, 20 cm, 25 cm, 30 cm, 35 cm, 40 cm, or the like. The powder dispenser outlet 206 needs to be positioned outside of the corona discharge zone.

When the angle α is either relatively small or relatively large, the following are important considerations to maximize transfer efficiency and coating uniformity by enabling saturation charge, minimizing corona suppression, and minimizing the impact of an incoming particle coating on the web 230 to deflect by reducing the vertical velocity vector of the incoming powder particle.

When the angle α is relatively small, such as between about 0° to 10°, it is most effective to direct the powder flow trajectory towards the bottom half of R, reducing the potential of corona discharge suppression. This will generally lead h_{d} to be less than hₑ.

When the angle α is relatively large, such as between about 55° to 85°, the exit velocity of the powder particles leaving the dispenser 205 should be relatively low. The velocity should be low as the vertical vector of the velocity increases with increase in the angle α. If the vertical velocity vector is too high when compared to the electrostatic force, the incoming powder particle will have a larger “impulse” which, when the particle collides with the web 230, the impulse may overcome the electrostatic attraction leading to deflection and low uniformity and transfer efficiency.

To expand and enhance the corona discharge zone, multiple wire electrodes 211a, 211b (e.g., first and second wire electrodes), as shown in FIG. 5, can be installed in the ESD chamber 210. Although two wire electrodes 211a, 211b are shown, it should be understood two or more wire electrodes could be included in the system. The wire electrodes 211a, 211b are generally arranged parallel to the first wire electrode 211 a (i.e., the nearest wire electrode to the dispenser outlet 206) to provide an extended corona discharge zone to charge powder particles that did not get charged effectively by preceding wire electrode(s) and provide additional electrostatic fields to steer the charged particles towards the web 230. The voltage for these wire electrodes 211a, 211b can be the same or different to optimize the effectiveness of particle charging. For example, the first wire electrode 211a can have a higher voltage than the second wire electrode 211b, or vice versa. The vertical distance between individual wire electrode 211a, 211b as measured relative to the web 230 can be the same or different. Generally, the second or n^{th} wire electrode (e.g., the last wire electrode) has the same or slightly less vertical distance between the web 230 as the first electrode or (n−1)^{th} electrode (e.g., the next to last wire electrode). The last electrode is preferably positioned more than 5 cm away from the web 230 vertically. The distance and the location of the wire electrodes 211a, 211b should be selected in such a way that the powder particles deposit in a uniform possible manner onto the continuous web 230, minimizing the amount of overspray and particle deposition on the internal walls of the ESD chamber 210.

For example, the separation distance between two adjacent wire electrodes 211a, 211b (d₂) should be dimensioned larger than interference zone R for these two respective electrodes 211a, 211b. The separation distance d₂ between two adjacent wire electrodes 211a, 211b can be between about R-2R (between about, e.g., 2-40 cm inclusive, 3-40 cm inclusive, 4-40 cm inclusive, 5-40 cm inclusive, 10-40 cm inclusive, 15-40 cm inclusive, 20-40 cm inclusive, 25-40 cm inclusive, 30-40 cm inclusive, 35-40 cm inclusive, 2-35 cm inclusive, 2-30 cm inclusive, 2-25 cm inclusive, 2-20 cm inclusive, 2-15 cm inclusive, 2-10 cm inclusive, 2-5 cm inclusive, 2-4 cm inclusive, 2-3 cm inclusive, 2 cm, 3 cm, 4 cm, 5 cm, 10 cm, 15 cm, 20 cm, 25 cm, 30 cm, 35 cm, 40 cm, or the like). The location of the last wire electrode 211b (i.e., the furthest wire electrode 211b from the powder dispenser outlet 206) is determined by the powder trajectory and location of powder deposition. As shown in FIG. 5, the distance d₃ between the furthest edge of powder deposition on the web 230 and the last electrode 211b should be not more than R, e.g., not more than about 20 cm. The edge of powder deposition on the web 230 is the farthest powder particles deposit on the web 230. The maximum wire electrode number (Ne) in the ESD chamber 210 can be determined by Equation 4:

$$Ne = \frac{d - {d}_{1} - {d}_{3}}{{d}_{2}} \qquad ( 4 )$$

where d is the horizontal distance between the furthest edge of powder deposition on the web 230 and the powder dispenser outlet 206, d₁ is the horizontal distance between the first wire electrode 211a and the powder dispenser outlet 206, d₂ is the separation distance between two adjacent wire electrodes 211a, 211b, and d₃ is the horizontal the distance between the furthest edge of powder deposition on the web 230 and the last electrode 211b.

To demonstrate the impact of utilizing multiple discharge electrodes to improve particle charging and thus transfer efficiency, an experiment was completed using two wire electrodes at applied voltage and compared to the results of the no applied voltage condition and the applied voltage only to electrode one condition. The geometric configuration was held constant for all the experiments. The height of electrode two was set to be the same as the height of electrode one at about 12.7 cm. Electrode two was placed downstream of electrode one by 25 cm, which is referenced as d2. The web speed was held constant at about 1 m/min and the web width was about 260 mm. The powder mass flow rate was held constant for all experiments. The transfer efficiency was calculated for each experimental condition. Experiment four was completed with electrode one and electrode two both brought to a potential of about 25 kV. The experimental setup results are summarized in FIG. 11. The transfer efficiency was calculated to be 31%. This is a 15% increase compared to when electrode two was at 0 potential and electrode one was at 25 kV potential. This is an increase of about 2.25× in transfer efficiency compared to the no applied voltage condition. The transfer efficiency results are summarized in FIG. 12.

The electrode drawer 212 is designed to support the wire electrodes 211a, 211b and can be fabricated from a non-conductive material, e.g., polycarbonate, or the like. Parallel (or substantially parallel) to each respective wire electrode 211a, 211b, one or more non-conductive angled shields (the deflector(s) 213a, 213b) are mounted within the electrode drawer 212. Each shield has two purposes: (a) during the charging process, this deflector 213a, 213b becomes charged at the same polarity of the corona wires (i.e., the electrodes 211a, 211b) and, therefore, enhances the flow of the ionized air towards the powder cloud, improving the charging process, and (b) the deflectors 213a, 213b provide a physical barrier and guide the aerodynamic flows coming out of the injector/diffuser arrangement towards the exit of the powder coating chamber 210, thereby promoting laminar air flow and preventing uncontrollable turbulence inside the electrostatic coating chamber 210. The distance between the wire electrode 211a, 211b and the respective deflector 213a, 213b can be between about, e.g., 1-10 cm inclusive, 2-10 cm inclusive, 3-10 cm inclusive, 4-10 cm inclusive, 5-10 cm inclusive, 6-10 cm inclusive, 7-10 cm inclusive, 8-10 cm inclusive, 9-10 cm inclusive, 1-9 cm inclusive, 1-8 cm inclusive, 1-7 cm inclusive, 1-6 cm inclusive, 1-5 cm inclusive, 1-4 cm inclusive, 1-3 cm inclusive, 1-2 cm inclusive, 1 cm, 2 cm, 3 cm, 4 cm, 5 cm, 6 cm, 7 cm, 8 cm, 9 cm, 10 cm, or the like.

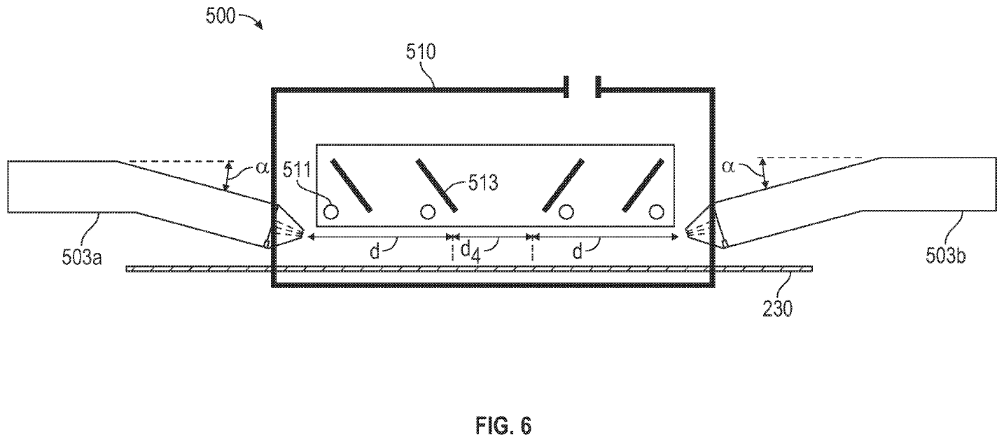

With reference to FIG. 6 in some embodiments, the applicator 500 (e.g., a system) can include two powder dispensers 503a, 503b. The two dispensers 503a, 503b can be oriented to face each other in a mirror image along the longitude direction of the web 230 on opposing sides of the ESD chamber 510. The dispensers 503a, 503b are located at the same vertical height relative to the web 230 and at the same (but mirror/opposing) position relative to the chamber 510. In the arrangement of FIG. 6, the dispensers 503a, 503b are configured to simultaneously (or selectively) coat the same surface of the web 230. In such arrangement, the position of the wire electrodes 511 and the deflectors 513 in the ESD chamber 510 can also be arranged in a mirror image relative to each other. For example, two wire electrodes 511 can be positioned on one side of the chamber 510 and associated with the dispenser 503a, and two wire electrodes 511 can be positioned on the opposing side of the chamber 510 and associated with the dispenser 503b. Deflectors 513 are positioned adjacent to the respective wire electrodes 511 and pairs of the deflectors 513 are angled in opposite directions to guide the powder towards the top surface of the web 230.

The horizontal distance between the two powder dispensers 503a, 503b is 2d+d₄. The horizontal distance between the two powder dispensers 503a, 503b is designed to be large enough so as to avoid interfering with the powder application from each powder dispenser 503a, 503b. On the other hand, the horizontal distance between the two powder dispensers 503a, 503b should not be unnecessarily large, which could result in a large footprint of the ESD chamber 510. Thus, in some embodiments, the distance between the two powder dispensers 503a, 503b can be twice the horizontal distance between edge of powder deposition on the web 230 and the powder dispenser outlet, plus about 0-20 cm (e.g., a range of about 2d to (2d+20) cm; such as about 50-100 cm inclusive, 60-100 cm inclusive, 70-100 cm inclusive, 80-100 cm inclusive, 9-100 cm inclusive, 50-90 cm inclusive, 50-80 cm inclusive, 50-70 cm inclusive, 50-60 cm inclusive, 50 cm, 60 cm, 70 cm, 80 cm, 90 cm, 100 cm, or the like).

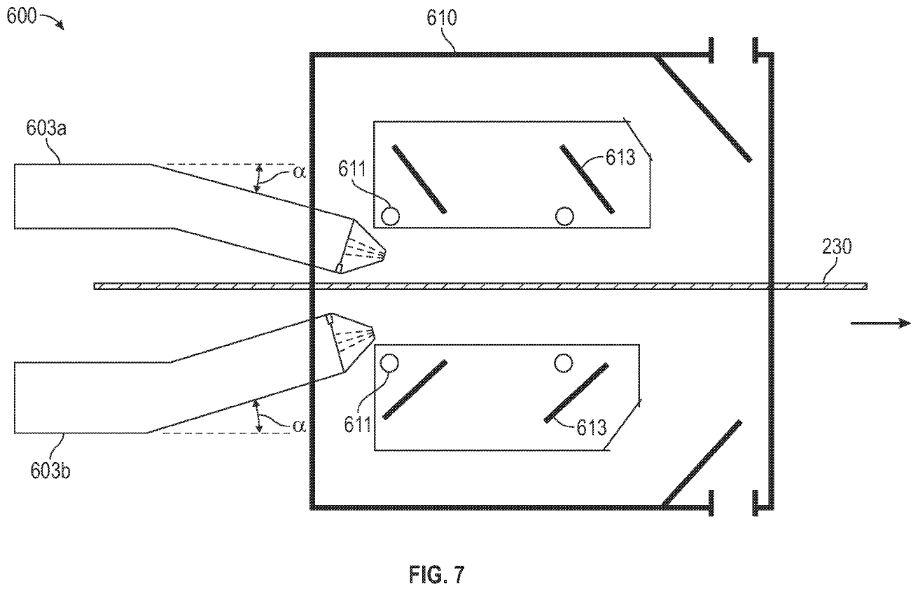

With reference to FIG. 7, in some embodiments, the applicator 600 can include two powder dispensers 603a, 603b arranged to simultaneously (or selectively) coat the opposing surfaces of the web 230. The dispensers 603a, 603b can be positioned on the same side of the chamber 610, but on opposing sides of the web 230, with the web 230 passing between the dispensers 603a, 603b. The dispensers 603a, 603b are therefore positioned in a mirror image arrangement on the top and back side of the web 230. In the arrangement of FIG. 7, wire electrodes 611 and deflectors 613 in the ESD chamber 610 are arranged on opposing sides of the web 230 and are associated with their respective dispensers 603a, 603b.

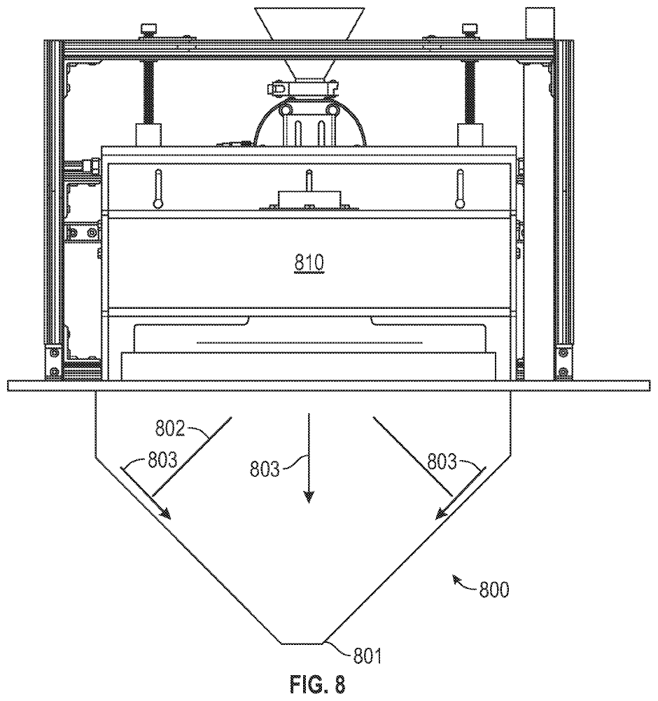

With reference to FIG. 8, the applicator/dispenser systems discussed herein can include a powder reclaiming system 800. The powder reclaiming system 800 can be disposed below the ESD chamber 810. The powder reclaiming system 800 serves the function of capturing all non-deposited powder (e.g., powder that misses the web 230) and reclaiming it for reuse so as to maximize material utilizations. To do this, powder reclaim locations are placed within the coating chamber 810 and collect powder via any dry bulk powder handling mechanisms, such as any single use or combination of: belt conveyors, pneumatic conveyors (positive or negative pressure), screw conveyors, vibratory conveyors, tube-and-chain conveyors, or the like. The powder reclaim system 800 collection ports 801 can be in any location within the coating chamber 810. In some embodiments, the ports 801 can be located such that they produce no or little disturbances to the powder trajectory. Baffles 802 are utilized near the collection ports 801 to diffuse any turbulent air from entering the powder coating regions. The baffles 802 assist with maintaining uniform laminar flow which is predictable at steady state coating conditions. The baffles 802 may be most useful when a pneumatic conveying system is utilized directly in the chamber 810.

The ports 801 should be close enough to the coating region so that volatile uncharged particles can be collected, but far enough away so that charged particle collection is minimized. Typically, the collection port 801 above the web can be positioned towards the far end of the coating chamber 810 from the powder dispenser. The collection port 801 underneath the web should be along the entire coating chamber 810 to properly collect any overspray. The diffusing baffles 802 can be parallel to the web motion as shown in FIG. 8 and assist with the powder flow direction 803. For a proper collection, the effective collection velocity can be slightly under pressure relative to the ESD chamber 810. In some embodiments, multiple applicators can be deployed in series along the longitude direction of the continuous moving web to increase coating thickness. The applicator discussed herein is suitable for solvent-free electrode coating for batteries, such as Li-ion batteries.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An applicator for electrostatic deposition of dry powder on a grounded continuous moving electrically conductive web, the applicator comprising:
a powder feeding system, at least one powder dispenser, an electrostatic deposition chamber, and at least one wire electrode in the electrostatic deposition chamber;
wherein an opening of a powder dispenser outlet of the at least one dispenser is arranged along a latitude of the electrically conductive web, and a ratio (P) of a width (W) of the opening and a coating width (L) of the electrically conductive web is in a range of about 0.25-1.0 cm;
wherein the at least one powder dispenser includes a defined angle (α) relative to the electrically conductive web and a vertical distance between the powder dispenser outlet and the electrically conductive web (h_{d});
wherein a first wire electrode of the at least one wire electrode generates a corona discharge zone with a radius (R) and is disposed at a vertical distance relative to the electrically conductive web (hₑ);
wherein the powder dispenser outlet and the first wire electrode are at a horizontal distance (d1); and
wherein the following relationship and condition is satisfied:
$$[ {tan}^{- 1} \frac{( {h}_{e} - {h}_{d} )}{d 1} - {sin}^{- 1} \frac{R}{\sqrt{{( {h}_{e} - {h}_{d} )}^{2} + d {1}^{2}}} ] < α < [ {tan}^{- 1} \frac{( {h}_{e} - {h}_{d} )}{d 1} + {sin}^{- 1} \frac{R}{\sqrt{{( {h}_{e} - {h}_{d} )}^{2} + d {1}^{2}}} ] .$$

2. The applicator of claim 1, wherein the electrostatic deposition chamber comprises two or more wire electrodes, wherein the two or more wire electrodes are arranged in parallel and cross the width of the continuous moving electrically conductive web.

3. The applicator of claim 1, wherein the radius (R) of the corona discharge zone generated by the first wire electrode is in a range of about 1 cm to 20 cm.

4. The applicator of claim 1, wherein the vertical distance between the first wire electrode and the electrically conductive web (hₑ) is in a range of about 2 cm to 30 cm.

5. The applicator of claim 1, wherein the vertical distance between the powder dispenser outlet and the electrically conductive web (ha) is in a range of about 2 cm to 70 cm.

6. The applicator of claim 1, wherein the powder dispenser outlet is arranged outside of the corona discharge zone generated by the first wire electrode.

7. The applicator of claim 1, wherein the horizontal distance between the at least one powder dispenser and the first wire electrode (d1) is about 2-40 cm.

8. The applicator of claim 2, wherein a number of the two or more wire electrodes (Nₑ) is determined by:
$$Ne = \frac{d - d 1 - d 3}{d 2} ,$$
where:
d is a horizontal distance between an edge of powder deposition on the electrically conductive web and the powder dispenser outlet;
d₁ is a horizontal distance between the first wire electrode and the powder dispenser outlet;
d₂ is a horizontal separation between two adjacent wire electrodes; and
d₃ is a horizontal distance between the edge of powder deposition on the electrically conductive web and a last wire electrode of the two or more wire electrodes.

9. The applicator of claim 8, wherein the horizontal separation between the two adjacent wire electrodes (d₂) is in a range of R to 2R.

10. The applicator of claim 8, wherein the horizontal distance (d₃) between the edge of powder deposition on the electrically conductive web and the last wire electrode is within the radius (R).

11. The applicator of claim 8, wherein a second or n^{th} wire electrode of the two or more wire electrodes has the same or slightly less vertical distance between the electrically conductive web as the first electrode or (n−1)^{th} wire electrode, and the vertical distance between the last wire electrode and the electrically conductive web is more than 5 cm.

12. The applicator of claim 1, wherein the at least one wire electrode includes two or more wire electrodes, and a voltage of two or more wire electrodes is different.

13. The applicator of claim 1, wherein the electrostatic deposition chamber comprises deflectors, wherein a number of the deflectors is equal to a number of wire electrodes.

14. The applicator of claim 1, comprising a powder reclaiming system.

15. The applicator of claim 14, wherein the powder reclaiming system includes at least one powder collection port with at least two turbulence eliminating baffles located in-between the electrically conductive web and the powder collection port.

16. The applicator of claim 15, wherein the powder collection port is disposed on top of the electrostatic deposition chamber, or at a bottom of the electrostatic deposition chamber, or a combination thereof.

17. The applicator of claim 1, wherein the at least one powder dispenser comprises two powder dispensers.

18. The applicator of claim 17, wherein the two powder dispensers are arranged to face each other along a longitude direction of the electrically conductive web in a mirror image orientation.

19. The applicator of claim 18, wherein a horizontal distance between the two powder dispensers is twice of a horizontal distance between an edge of powder deposition on the electrically conductive web and a powder dispenser outlet plus about 0-20 cm.

20. The applicator of claim 17, wherein the two powder dispensers are arranged on a top side of the electrically conductive web and a back side of the electrically conductive web with a mirror image orientation.
